(19) United States
(12) Patent Application Publication
(10) Pub. No.: US 2001/0026684 A1
(43) Pub. Date: Oct. 4, 2001

(54) Aid for panoramic image creation

(75) Inventors: Noam Sorek, Zichron Yaakov (IL); Ilia Vitsnudel, Even Yehuda (IL); Ron Fridental, Herzelia (IL); Philip Alper, D.N. Misgav (IL)

Correspondence Address: OSTROLENK FABER GERB & SOFFEN, 1180 AVENUE OF THE AMERICAS, NEW YORK, NY, 100368403

(73) Assignee: ALST TECHNICAL EXCELLENCE CENTER

(21) Appl. No.: 09/775,071

(22) Filed: Feb. 1, 2001

Related U.S. Application Data
(60) Provisional application No. 60/179,956, filed on Feb. 3, 2000.

(51) Int. Cl. G03B 41/00

(52) U.S. Cl. 396/322

(57) ABSTRACT

Apparatus for producing a panoramic image of a scene, including an image capture device, which is adapted to capture a plurality of sub-images of the scene at a respective plurality of orientations of the device. The apparatus further includes a direction indicator, which is coupled to the image capture device so as to determine the orientation of the device and to indicate the orientations at which the sub-images should be captured so that the plurality of sub-images can be stitched together to form the panoramic image of the scene. The apparatus is able to produce a panoramic image of a horizontal or of a vertical scene.

### CROSS-REFERENCE TO RELATED APPLICATIONS

This application claims the benefit of U.S. Provisional Patent Application No. 60/179,956, filed Feb. 3, 2000, which is incorporated herein by reference.

### FIELD OF THE INVENTION

The present invention relates generally to imaging systems, and specifically to generation of images of panoramic scenes.

### BACKGROUND OF THE INVENTION

Methods for producing a panoramic image of a scene, herein assumed to be a view as seen when turning about an axis, are well known in the art. For example, a fish-eye lens, which has a field-of-view in all directions of approximately 180°, can generate a 180° panoramic image. Alternatively, two or more fish-eye lenses, or a wide angle lens with an external mirror, can be used to generate a 360° panoramic image. Optionally, the panoramic image is acquired in digital form. In order to view the image, separate viewing software, which applies fish-eye correcting transforms, is used to display a specific section of the panoramic image. However, fish-eye lenses are relatively expensive. Moreover, the resolution of images produced by fish-eye lenses with appropriate sensors is not uniform, being highest near the axis of the lens, and decreasing substantially at angles far from the axis.

An alternative method for producing a panoramic image is to use a camera with a standard lens. The camera is rotated or panned about an axis, and a number of overlapping sub-images of the scene are taken. The sub-images are formed into a panoramic image by correlating and “stitching” the sub-images together, by methods known in the imaging art. For example, Panavue Company of Quebec City, Canada, produce the “PanaVue ImageAssembler” which is an image stitching software which generates panoramas from multiple photographs. Typically, an overlap between adjacent sub-images of about 30% is required in order to achieve a good combination of sub-images. While systems using standard lenses do achieve a substantially constant resolution over the panoramic image, the production of sub-images is not straightforward.

U.S. Pat. No. 5,752,113, to Borden, whose disclosure is incorporated herein by reference, describes a camera frame to which is attached a mount, for the purpose of taking a panoramic image. The mount comprises a rotational advance system which enables the frame to be rotated by discrete angles, thus simplifying the task of correctly aiming the camera during production of the sub-images.

FIG. 1 is a schematic illustration of some of the problems which occur when producing a panoramic image with a standard lens, as are known in the art. In rotating the camera, too large an overlap 6, or insufficient overlap 7, between adjacent sub-images may be produced. Furthermore, in rotating or panning the camera, deviations from an initial rotation plane 8 can easily occur, leading to a reduction in the region of each sub-image which is useable for producing the panoramic image.

### SUMMARY OF THE INVENTION

It is an object of some aspects of the present invention to provide a method and apparatus for simplifying the generation of a panoramic image of a scene.

It is a further object of some aspects of the present invention to provide a method and apparatus for automatically generating a panoramic image of a scene.

In preferred embodiments of the present invention, a direction indicator is attached to an image capture device which is used to produce a panoramic image of a scene. The direction indicator preferably comprises a permanent magnet and a level, which are both utilized by the indicator in determining a direction in which the image capture device is pointed. The panoramic image is produced by photographing a plurality of overlapping still sub-images of the scene, at directions and in orientations which are indicated by the indicator, while panning or rotating the device about an axis.

Most preferably, the image capture device is a digital camera which produces the plurality of still sub-images as digital files. After the plurality of still sub-images have been generated, the overlapping sub-images are combined together using correlation and “stitching” methods known in the art, so as to produce one panoramic image of the scene. The coupling of the direction indicator to the camera enables the latter to be pointed so that the plurality of still sub-images overlap sufficiently for generating the panoramic image, while not overlapping excessively. The level comprised in the indicator ensures that the camera is correctly oriented relative to the axis when each of the plurality of sub-images are generated.

In some preferred embodiments of the present invention, the direction indicator comprises one or more devices which automatically provide a signal corresponding to a direction and/or orientation of the indicator. The image capture device most preferably comprises a central processing unit (CPU) which receives the signal, and responsive thereto automatically activates the image capture device to generate the plurality of sub-images of the scene as the device is panned or rotated. The image capture device is automatically activated so that sufficient sub-images are generated, with sufficient but not excessive overlap between the sub-images, for subsequent production of the panoramic image. Alternatively or additionally, the signal is used as a parameter for improving the quality of the correlation and stitching of the plurality of sub-images.

In some preferred embodiments of the present invention the axis about which the image capture device is rotated is a substantially vertical axis, and the panoramic image is in a horizontal plane at right angles to the axis of rotation. In an alternative preferred embodiment of the present invention, the image capture device is rotated about a substantially horizontal axis, so that the panoramic image is in a vertical plane at right angles to the horizontal rotation axis. In both cases, the direction indicator is utilized to maintain the chosen axis of rotation (horizontal or vertical) substantially constant in direction.

There is therefore provided, according to a preferred embodiment of the present invention, apparatus for producing a panoramic image of a scene, including:

an image capture device, which is adapted to capture a plurality of sub-images of the scene at a respective plurality of orientations of the device; and

a direction indicator, which is coupled to the image capture device so as to determine the orientation of the device and to indicate the orientations at which the sub-images should be captured so that the plurality of sub-images can be stitched together to form the panoramic image of the scene.

Preferably, the image capture device includes a memory wherein the plurality of sub-images are stored.

Further preferably, the memory includes a volatile memory.

Alternatively, the memory includes a non-volatile memory.

Preferably, the image capture device includes a central processing unit (CPU) which stitches the plurality of sub-images together to form the panoramic image of the scene.

Preferably, the direction indicator includes one or more signal generators which transmit the plurality of orientations to the CPU, and the CPU stitches the plurality of sub-images together responsive to the received plurality of orientations.

Preferably, the direction indicator includes one or more signal generators which transmit the plurality of orientations to the CPU, and the CPU operates the image capture device so as to capture the plurality of sub-images responsive to the received plurality of orientations.

Preferably, the direction indicator includes:

a first direction indicator section which is substantially fixedly coupled to the image capture device, so that the plurality of orientations of the device correspond to a respective plurality of orientations of the first section; and

a second direction indicator section which is substantially invariant in orientation, so that comparison of the orientation of the first section with the orientation of the second section provides the orientation of the device.

Further preferably, the second direction indicator section includes an asymmetrical mass which maintains an orientation of the second direction indicator section substantially fixed relative to the Earth's gravitational field.

Further preferably, the second direction indicator section includes a permanent magnet which maintains an orientation of the second direction indicator section substantially fixed relative to the Earth's magnetic field.

Preferably, the image capture device includes a predetermined field-of-view, and the plurality of sub-images include a predetermined overlap between adjacent sub-images, and the second direction indicator section includes a respective plurality of markings, responsive to the field-of-view and the overlap, which indicate the plurality of orientations.

Further preferably, the image capture device captures the scene by being rotated about a substantially vertical axis, and the field-of-view of the device includes a predetermined horizontal field-of-view, and the plurality of markings include a respective plurality of longitudinal markings.

Alternatively, the image capture device captures the scene by being rotated about a substantially horizontal axis, and the field-of-view of the device includes a predetermined vertical field-of-view, and the plurality of markings include a respective plurality of latitudinal markings.

Preferably, the scene includes a view formed by rotating about an axis by an angle substantially equal to 360°.

Alternatively, the scene includes a view formed by rotating about an axis by an angle less than 360°.

There is further provided, according to a preferred embodiment of the present invention, a method for producing a panoramic image of a scene, including:

coupling a direction indicator to an image capture device so as to determine orientation coordinates of the device; and

generating a plurality of sub-images of the scene at a respective plurality of orientation coordinates of the image capture device indicated by the direction indicator, so that the plurality of sub-images can be stitched together to form the panoramic image of the scene.

Preferably, the image capture device includes a memory, and generating the plurality of sub-images includes storing the plurality of sub-images in the memory.

Preferably, the method includes providing a central processing unit (CPU), and generating the plurality of sub-images includes operating the CPU so as to stitch the plurality of sub-images together to form the panoramic image of the scene.

Further preferably, the method includes providing one or more signal generators which transmit the plurality of orientations to the CPU, and stitching the plurality of sub-images together includes stitching the plurality of sub-images together responsive to the transmitted plurality of orientations.

Preferably, the method includes providing one or more signal generators which transmit the plurality of orientations to the CPU, and generating the plurality of sub-images includes generating the plurality of sub-images together responsive to the transmitted plurality of orientations.

Preferably, coupling the direction indicator to the image capture device includes maintaining an orientation of a section of the direction indicator substantially fixed relative to the Earth's gravitational field.

Alternatively, coupling the direction indicator to the image capture device includes maintaining an orientation of a section of the direction indicator substantially fixed relative to the Earth's magnetic field.

Preferably, generating the plurality of sub-images includes generating the sub-images responsive to a predetermined field-of-view of the image capture device and to a predetermined overlap between adjacent sub-images.

Further preferably, generating the plurality of sub-images includes rotating the image capture device about a substantially vertical axis, and the field-of-view of the device includes a predetermined horizontal field-of-view.

Alternatively, generating the plurality of sub-images includes rotating the image capture device about a substantially horizontal axis, and the field-of-view of the device includes a predetermined vertical field-of-view.

Preferably, generating the plurality of sub-images includes rotating the image capture device about an axis by an angle substantially equal to 360°.

Alternatively, generating the plurality of sub-images includes rotating the image capture device about an axis by an angle substantially less than 360°.

There is further provided, according to a preferred embodiment of the present invention, a method for producing a panoramic image of a scene, including:

pointing an image capture device in an initial direction at the scene;

displaying an initial sub-image on a screen responsive to the initial direction;

capturing the initial sub-image of the scene;

translating the initial sub-image a predetermined distance on the screen to form a translated sub-image;

moving the image capture device to point in a subsequent direction so as to align a subsequent sub-image of the scene, displayed on the screen responsive to the subsequent direction, with the translated sub-image;

capturing the subsequent sub-image of the scene; and

stitching the initial sub-image and the subsequent sub-image together to form the panoramic image of the scene.

Preferably, the method includes:

translating the subsequent sub-image the predetermined distance on the screen to form a second translated sub-image;

moving the image capture device to point in a second subsequent direction so as to align a second subsequent sub-image of the scene, displayed on the screen responsive to the second subsequent direction, with the second translated sub-image;

capturing the second subsequent sub-image; and

stitching the initial sub-image and the subsequent sub-image and the second subsequent sub-image together to form the panoramic image of the scene.

There is further provided, according to a preferred embodiment of the present invention, apparatus for producing a panoramic image of a scene, including:

an image capture device which is pointed in an initial direction at the scene;

a screen which displays an initial sub-image responsive to the initial direction; and

a central processing unit (CPU) which is adapted to capture the initial sub-image of the scene, and to translate the initial sub-image a predetermined distance on the screen to form a translated sub-image,

wherein the image capture device is moved to point in a subsequent direction so as to align a subsequent sub-image of the scene, displayed on the screen responsive to the subsequent direction, with the translated sub-image, and wherein the CPU is adapted to capture the subsequent sub-image of the scene and to stitch the initial sub-image and the subsequent sub-image together to form the panoramic image of the scene.

The present invention will be more fully understood from the following detailed description of the preferred embodiments thereof, taken together with the drawings, in which:

### BRIEF DESCRIPTION OF THE DRAWINGS

FIG. 1 is a schematic illustration of some of the problems which occur when producing a panoramic image with a standard lens, as are known in the art;

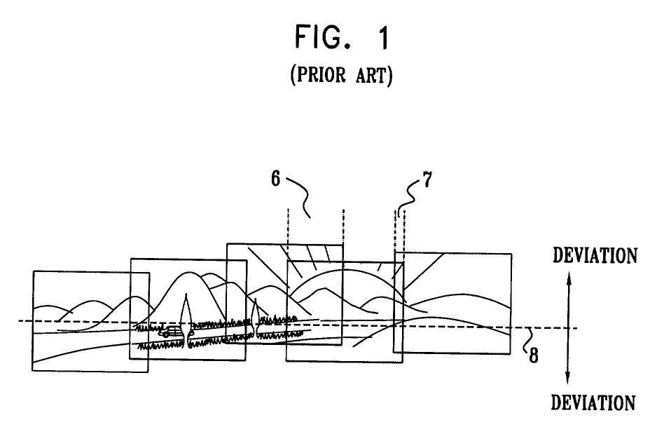

FIG. 2 is a schematic perspective diagram of a direction indicator coupled to a camera to form a panoramic imaging system, according to a preferred embodiment of the present invention;

FIG. 3 is a schematic diagram of a top view of the imaging system of FIG. 2, according to a preferred embodiment of the present invention;

FIG. 4 is a flowchart showing a process for producing a panoramic image of a scene, using the system of FIG. 2, according to a preferred embodiment of the present invention;

FIG. 5 is a schematic drawing of a panoramic imaging system, according to an alternative preferred embodiment of the present invention;

FIG. 6 is a flowchart showing a process for automatic generation of a panoramic image of a scene using the system of FIG. 5, according to a preferred embodiment of the present invention; and

FIG. 7 is a schematic diagram of a series of sections of a panoramic scene, according to a further alternative preferred embodiment of the present invention.

### DETAILED DESCRIPTION OF PREFERRED EMBODIMENTS

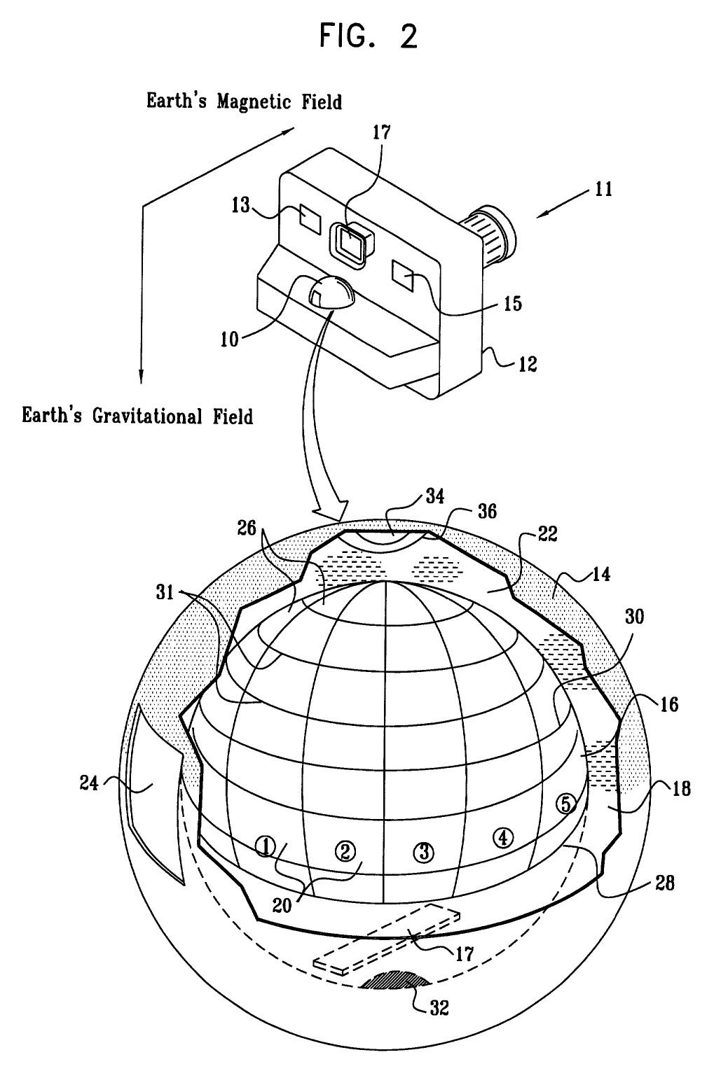

Reference is now made to FIG. 2, which is a schematic perspective diagram of a direction indicator 10 coupled to an image capture device 12, hereinbelow assumed to be a camera, to form a panoramic imaging system 11, according to a preferred embodiment of the present invention. Most preferably, camera 12 comprises a digital camera which is operated by a central processing unit (CPU) 13 integral to the camera. Camera 12 also comprises a non-volatile and/or a volatile memory 15, wherein digital data corresponding to images produced by the camera can be stored. Typically, an image of a scene to be photographed by camera 12 is visible on a screen 17 comprised in the camera. Direction indicator 10 preferably comprises a spherical or partly spherical transparent outer container 14 which is fixedly attached to camera 12. Within container 14 is a movable image indicator 16, which most preferably comprises a permanent magnet 17 so that image indicator 16 has a tendency to point in a fixed direction. Most preferably, image indicator 16 floats in a transparent fluid 18 held by container 14, so that indicator 16 does not contact the container and is free to rotate about any axis passing through a center of the container.

Indicator 16 is divided into a plurality of substantially similar numbered contiguous sectors 20. Each sector 20 of indicator 16 is bounded by markings comprising a pair of longitudinal lines 26, an equatorial line 28, and a non-equatorial latitudinal line 30 inscribed on indicator 16. Most preferably, indicator 16 comprises a mass 32 which is asymmetrically positioned within the indicator so that lines 28 and 30 are maintained in a substantially horizontal plane regardless of the orientation of system 10. Preferably, container 14 comprises an opaque shield 22 having an opening 24. Opening 24 is sized so that when a specific sector 20 is aligned with the opening, the complete sector, and substantially no portions of adjacent sectors, are visible through the opening.

The plurality of sectors 20 into which indicator 16 is divided, corresponding to the plurality of longitudinal lines 26, is a function of the horizontal field-of-view of camera 12 and of the required overlap of the sub-images produced by camera 12, as is described in detail hereinbelow. Sectors 20 are used for generating a panoramic image of a horizontal panorama. (Preferably, a plurality of non-equatorial latitudinal lines 31, corresponding to the vertical field-of-view of camera 12, are inscribed on indicator 16. Lines 31 are used for generating a panoramic image of a vertical panorama, as is also described in detail hereinbelow.)

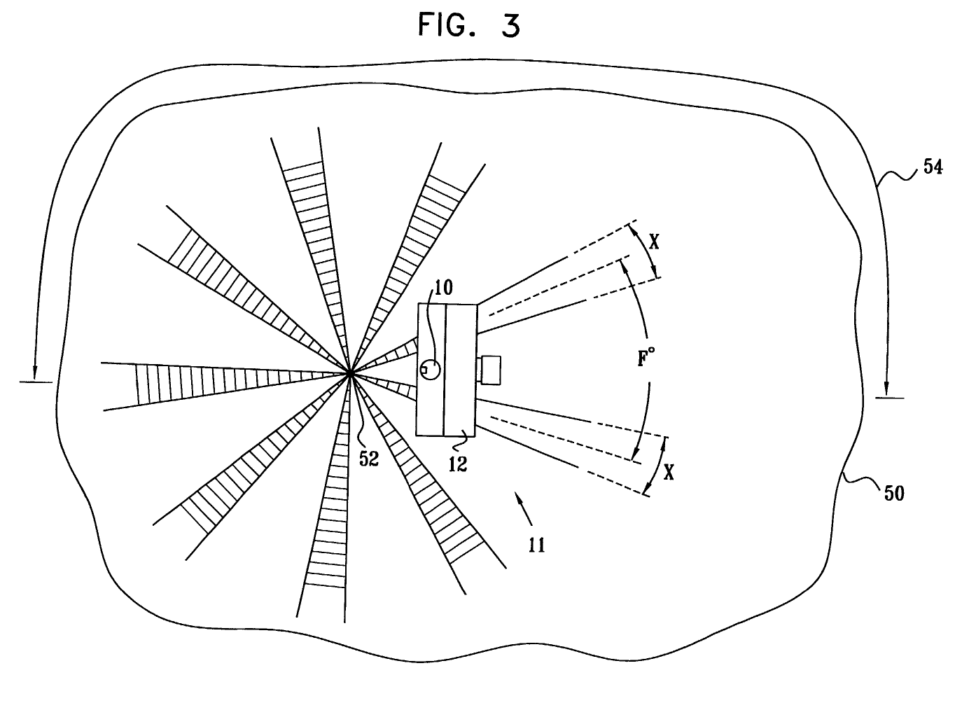

FIG. 3 is a schematic diagram of a top view of imaging system 11, according to a preferred embodiment of the present invention. System 11 is used to form a panoramic image of a 360° scene 50 lying in a generally horizontal plane, by rotating the system about a vertical axis 52. It is assumed herein that camera 12 has a horizontal field-of-view substantially equal to F. It is further assumed that in order to achieve acceptable overlap between adjacent sub-images produced by camera 12, the sub-images overlap by a fraction x of F (0<x<1). In order to generate sufficient sub-images to cover scene 50, the plurality of sub-images which need to be imaged is thus given by:

$$P = [ \frac{360}{F \cdot ( 1 - x )} ] \qquad ( 1 )$$

wherein [a] is assumed to be the smallest integer equal to or greater than a, and P corresponds to the value of the plurality. The plurality of sectors 20 of indicator 16 is set to correspond to this plurality, by appropriate construction of lines 26, and opening 24 is formed, as described above, according to the size of sectors 20.

For example, for a camera having a field-of-view 60°, and where an acceptable overlap is assumed to be ⅓ of this field of view, equation (1) gives the plurality P as equal to 9. In this case, the nine longitudinal lines 26 are separated by 40°, and there are nine sectors 20 formed within lines 26. The nine sectors are preferably numbered from 1 through to 9. It will be appreciated that the above values of field-of-view and overlap are by way of example, and that other values of field-of-view and of image overlap can be used to determine the value of the plurality of longitudinal lines 26 and sectors 20. Sectors 20 are then numbered according to the value of the plurality.

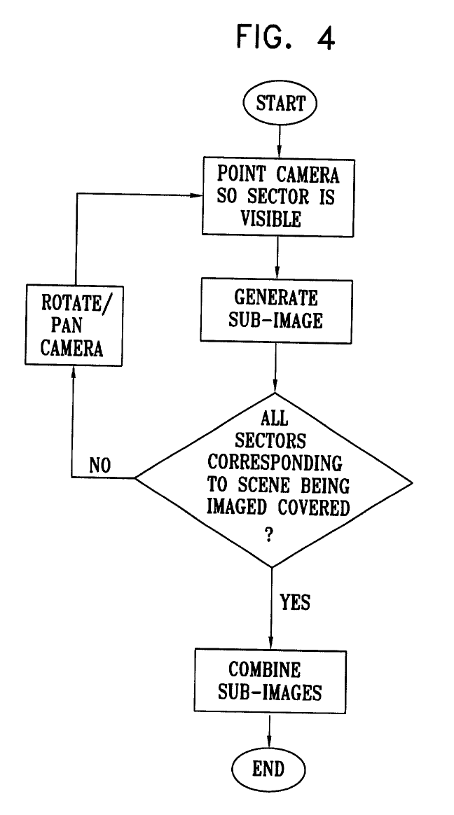

FIG. 4 is a flowchart showing a process for producing a panoramic image of scene 50, using system 11, according to a preferred embodiment of the present invention. In an initial step, system 11 is pointed by an operator of the system so that a first sector 20 is visible through opening 24. The operator activates camera 12 to generate a corresponding first sub-image which is stored in memory 15. Most preferably, the operator then pans system 11 about axis 52 until a second sector 20 is visible in opening 24, and camera 12 is again activated to generate and store a second sub-image. The process of panning system 11 and generating and storing sub-images as each sector becomes visible is continued until all sectors corresponding to the scene being imaged have been covered. Alternatively, instead of panning system 11, the system is rotated about axis 52. The stored sub-images are then combined by CPU 13, using one of the image stitching processes known in the art, to produce the panoramic image of scene 50.

Most preferably, as system 11 is rotated, the system is maintained in a substantially horizontal orientation by aligning upper and lower horizontal edges of opening 24 with an equatorial line 28, and a non-equatorial latitudinal line 30 respectively. Alternatively, system 11 is maintained in a substantially horizontal orientation by other means known in the art, such as aligning a bubble 34 in fluid 18 with a mark 36 on container 14.

It will be appreciated that system 11 and the process described with reference to FIG. 4 can produce a panoramic image of part of scene 50 (FIG. 3). Section 54 of scene 50 corresponds to a rotation of approximately 180° about axis 52. In order to produce a panoramic image of section 54, correspondingly fewer than all sectors 20, i.e., five sectors 20, need to be covered in order for the 180° panoramic image to be producible. Thus the process described with reference to FIG. 4 is terminated after five sectors 20 have been covered.

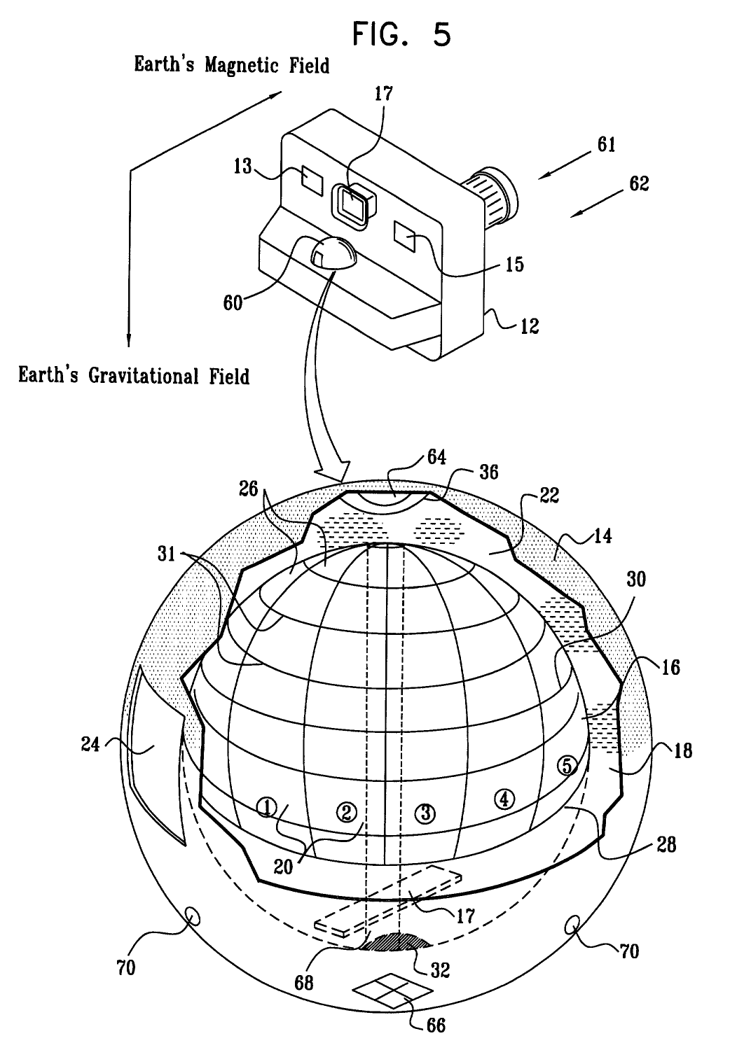

FIG. 5 is a schematic drawing of a panoramic imaging system 61, according to an alternative preferred embodiment of the present invention. Apart from the differences described below, the operation of system 61 is generally similar to that of system 11 (FIG. 2), so that elements indicated by the same reference numerals in both systems 61 and 11 are generally identical in construction and in operation. A direction indicator 60, generally similar to indicator 10, comprises an automatic direction readout device 62, which generates a signal responsive to the direction, and/or inclination to the horizontal, of indicator 60. Most preferably, device 62 comprises a light emitting diode (LED) 64 mounted at the top of container 14, and a quadrant photometer 66 mounted at the base of the container. A cylindrical opening 68 is provided in indicator 16 so that light from LED 64 is incident on photometer 66, which is coupled to CPU 13. It will be appreciated that signal levels generated by the different quadrants of photometer 66 can be utilized by CPU 13 to provide a value of the inclination of indicator 60 to the horizontal, by methods known in the art.

Device 62 further most preferably comprises one or more Hall sensors 70, mounted on the side of container 14, which are coupled to CPU 13. Signals from the one or more Hall sensors are utilized by CPU 13 to produce a value of the direction of indicator 60, responsive to the orientation of permanent magnet 17. Alternatively, device 62 comprises systems known in the art, other than those described hereinabove, for generating a signal responsive to the direction and/or inclination to the horizontal of indicator 60.

In some preferred embodiments of the present invention, values of direction and/or inclination of device 62 are used as one or more parameters so as to improve the production of the panoramic image of scene 50. It will be appreciated that knowledge of the direction and/or inclination of device 62, and consequently of camera 12 for each sub-image, enables adjacent sub-images to be correlated and/or stitched together more efficiently and with improved accuracy by CPU 13.

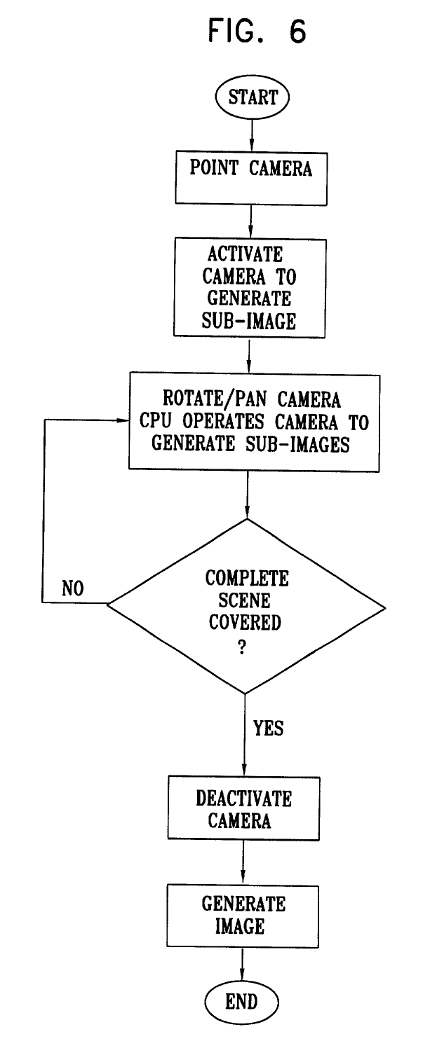

FIG. 6 is a flowchart showing a process for automatic generation of a panoramic image of a scene using system 61, according to a preferred embodiment of the present invention. In a first step, camera 12 is pointed at any portion of the scene, and the camera is activated to produce a first sub-image. The camera is then rotated or panned about vertical axis 52, while being kept substantially horizontally oriented as described above. As the camera rotates or pans, CPU 13 uses signals from automatic direction readout device 62 so as to activate camera 12 when the camera is correctly aligned for producing subsequent sub-images. The process of producing sub-images continues until the complete scene required has been covered, as seen in screen 17 by an operator of system 61. At this point the camera is deactivated by the operator, or if the scene is a 360° scene, automatically by CPU 13. CPU 13 then correlates and/or stitches the sub-images together, as described hereinabove, to produce a panoramic image of the scene. It will be appreciated that the process described hereinabove applies to scenes subtending angles less than or equal to 360°.

Referring back to FIG. 2, it will be appreciated that preferred embodiments of the present invention utilize the Earth's gravitational field as a vertical reference around which system 11 or system 61 is rotated in order to image a horizontal panorama. Correspondingly, the Earth's magnetic field is used as a horizontal reference to maintain the direction indicator of the respective system in a fixed direction. It will thus be appreciated that preferred embodiments of the present invention can be utilized to produce a panoramic image of a vertical panorama, such as is generated by rotating or panning system 11 or system 61 about a horizontal axis. In this case, the Earth's gravitational field is used as a vertical reference to maintain the direction indicator of the respective system in a fixed direction. The Earth's magnetic field, or a component thereof, is used to define the horizontal axis about which system 11 or system 61 is rotated.

It will further be appreciated that for vertical panoramas equation (1) may be used to calculate the value of the plurality of sub-images, by substituting the vertical field-of-view of camera 12 for F. Most preferably, the corresponding plurality of non-equatorial latitudinal lines 31 are inscribed on indicator 16 according to the plurality P calculated by equation (1). When system 11 is operated to generate an image of a vertical panoramic scene, substantially according to the process described with reference to FIG. 3, lines 31 are utilized as guide lines indicating when a sub-image is to be generated. When system 61 is used to generate the image of the vertical panoramic scene, substantially according to the process described with reference to FIG. 5, CPU 13 utilizes the value of P calculated for the vertical field-of-view.

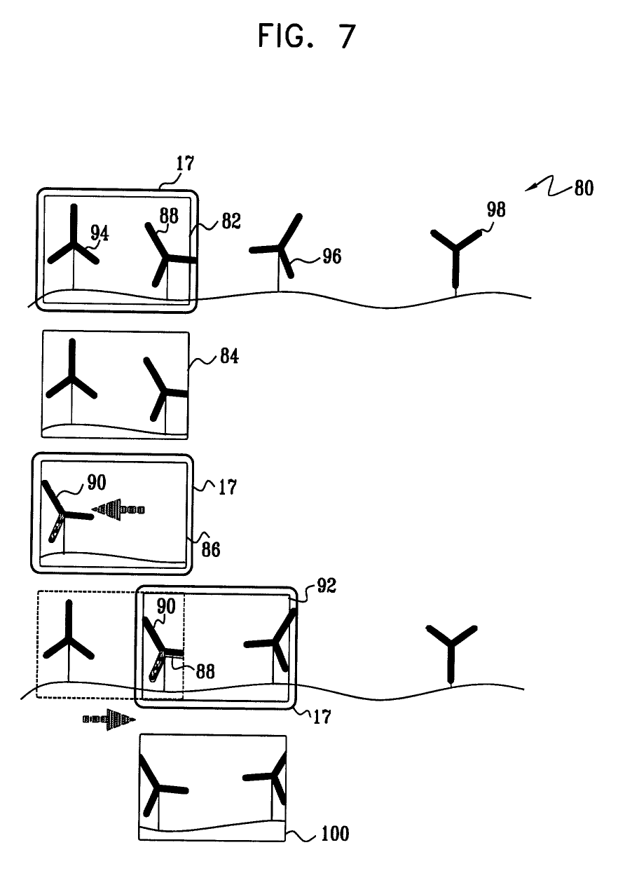

FIG. 7 is a schematic diagram of a series of sections of a panoramic scene, according to a further alternative preferred embodiment of the present invention. A scene 80 comprising windmills 94, 88, 96, and 98 is imaged by system 11 (FIG. 2). It will be appreciated that scene 80 is used by way of example, and that any other scene can be imaged by system 11. Initially a section 82 of scene 80 is imaged on screen 17 of camera 12, and an operator of the camera captures section 82, as an image 84. Image 84 is stored in memory 15 by CPU 13. Once section 82 has been captured, CPU 13 translates image 84 on screen 17 by approximately 80% of the width of the screen to generate a fixed image 86 on the screen. Herein, “fixed” is to be understood as stationary with respect to screen 17. In FIG. 7, an image of windmill 88 is translated to appear as a fixed translated image 90. Preferably, image 90 is overlaid on image 84. Most preferably, translated image 90 is altered by methods known in the art, such as changing the brightness and/or the color and/or by outlining the image, so as to enable the operator to easily differentiate the translated image from image 84. Alternatively or additionally, image 84 is altered as described above.

Once translated fixed image 90 is available, the operator of camera 12 rotates the camera so as to re-align the image produced on screen 17 with the fixed image. In FIG. 7, camera 12 is rotated so that the image of windmill 88 and translated image 90 substantially coincide. A new section 92 of scene 80 is thus imaged on screen 17, and the operator then captures the section as an image 100, which is stored in memory 15 by CPU 13. The process described hereinabove continues until as much of scene 80 as is desired by the operator has been imaged as a plurality of sections. The sections are then stitched together, as described above, to generate a panoramic scene.

It will be appreciated that the process described hereinabove with reference to FIG. 7 can be applied to produce horizontal or vertical panoramic images, and that this process enables an operator to easily and intuitively generate sections of a scene which will have correct overlapping between the scenes.

It will be further appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for producing a panoramic image of a scene, comprising:
an image capture device, which is adapted to capture a plurality of sub-images of the scene at a respective plurality of orientations of the device; and
a direction indicator, which is coupled to the image capture device so as to determine the orientation of the device and to indicate the orientations at which the sub-images should be captured so that the plurality of sub-images can be stitched together to form the panoramic image of the scene.

2. Apparatus according to claim 1, wherein the image capture device comprises a memory wherein the plurality of sub-images are stored.

3. Apparatus according to claim 2, wherein the memory comprises a volatile memory.

4. Apparatus according to claim 2, wherein the memory comprises a non-volatile memory.

5. Apparatus according to claim 1, wherein the image capture device comprises a central processing unit (CPU) which stitches the plurality of sub-images together to form the panoramic image of the scene.

6. Apparatus according to claim 5, wherein the direction indicator comprises one or more signal generators which transmit the plurality of orientations to the CPU, and wherein the CPU stitches the plurality of sub-images together responsive to the received plurality of orientations.

7. Apparatus according to claim 5, wherein the direction indicator comprises one or more signal generators which transmit the plurality of orientations to the CPU, and wherein the CPU operates the image capture device so as to capture the plurality of sub-images responsive to the received plurality of orientations.

8. Apparatus according to claim 1, wherein the direction indicator comprises:
a first direction indicator section which is substantially fixedly coupled to the image capture device, so that the plurality of orientations of the device correspond to a respective plurality of orientations of the first section; and
a second direction indicator section which is substantially invariant in orientation, so that comparison of the orientation of the first section with the orientation of the second section provides the orientation of the device.

9. Apparatus according to claim 8, wherein the second direction indicator section comprises an asymmetrical mass which maintains an orientation of the second direction indicator section substantially fixed relative to the Earth's gravitational field.

10. Apparatus according to claim 8, wherein the second direction indicator section comprises a permanent magnet which maintains an orientation of the second direction indicator section substantially fixed relative to the Earth's magnetic field.

11. Apparatus according to claim 8, wherein the image capture device comprises a predetermined field-of-view, and wherein the plurality of sub-images comprise a predetermined overlap between adjacent sub-images, and wherein the second direction indicator section comprises a respective plurality of markings, responsive to the field-of-view and the overlap, which indicate the plurality of orientations.

12. Apparatus according to claim 11, wherein the image capture device captures the scene by being rotated about a substantially vertical axis, and wherein the field-of-view of the device comprises a predetermined horizontal field-of-view, and wherein the plurality of markings comprise a respective plurality of longitudinal markings.

13. Apparatus according to claim 11, wherein the image capture device captures the scene by being rotated about a substantially horizontal axis, and wherein the field-of-view of the device comprises a predetermined vertical field-of-view, and wherein the plurality of markings comprise a respective plurality of latitudinal markings.

14. Apparatus according to claim 1, wherein the scene comprises a view formed by rotating about an axis by an angle substantially equal to 360°.

15. Apparatus according to claim 1, wherein the scene comprises a view formed by rotating about an axis by an angle less than 360°.

16. A method for producing a panoramic image of a scene, comprising:
coupling a direction indicator to an image capture device so as to determine orientation coordinates of the device; and
generating a plurality of sub-images of the scene at a respective plurality of orientation coordinates of the image capture device indicated by the direction indicator, so that the plurality of sub-images can be stitched together to form the panoramic image of the scene.

17. A method according to claim 16, wherein the image capture device comprises a memory, and wherein generating the plurality of sub-images comprises storing the plurality of sub-images in the memory.

18. A method according to claim 16, and comprising providing a central processing unit (CPU), wherein generating the plurality of sub-images comprises operating the CPU so as to stitch the plurality of sub-images together to form the panoramic image of the scene.

19. A method according to claim 18, and comprising providing one or more signal generators which transmit the plurality of orientations to the CPU, wherein stitching the plurality of sub-images together comprises stitching the plurality of sub-images together responsive to the transmitted plurality of orientations.

20. A method according to claim 18, and comprising providing one or more signal generators which transmit the plurality of orientations to the CPU, wherein generating the plurality of sub-images comprises generating the plurality of sub-images together responsive to the transmitted plurality of orientations.

21. A method according to claim 16, wherein coupling the direction indicator to the image capture device comprises maintaining an orientation of a section of the direction indicator substantially fixed relative to the Earth's gravitational field.

22. A method according to claim 16, wherein coupling the direction indicator to the image capture device comprises maintaining an orientation of a section of the direction indicator substantially fixed relative to the Earth's magnetic field.

23. A method according to claim 16, wherein generating the plurality of sub-images comprises generating the sub-images responsive to a predetermined field-of-view of the image capture device and to a predetermined overlap between adjacent sub-images.

24. A method according to claim 23, wherein generating the plurality of sub-images comprises rotating the image capture device about a substantially vertical axis, and wherein the field-of-view of the device comprises a predetermined horizontal field-of-view.

25. A method according to claim 23, wherein generating the plurality of sub-images comprises rotating the image capture device about a substantially horizontal axis, and wherein the field-of-view of the device comprises a predetermined vertical field-of-view.

26. A method according to claim 16, wherein generating the plurality of sub-images comprises rotating the image capture device about an axis by an angle substantially equal to 360°.

27. A method according to claim 16, wherein generating the plurality of sub-images comprises rotating the image capture device about an axis by an angle substantially less than 360°.

28. A method for producing a panoramic image of a scene, comprising:
pointing an image capture device in an initial direction at the scene;
displaying an initial sub-image on a screen responsive to the initial direction;
capturing the initial sub-image of the scene;
translating the initial sub-image a predetermined distance on the screen to form a translated sub-image;
moving the image capture device to point in a subsequent direction so as to align a subsequent sub-image of the scene, displayed on the screen responsive to the subsequent direction, with the translated sub-image;
capturing the subsequent sub-image of the scene; and
stitching the initial sub-image and the subsequent sub-image together to form the panoramic image of the scene.

29. A method according to claim 28, and comprising:
translating the subsequent sub-image the predetermined distance on the screen to form a second translated sub-image;
moving the image capture device to point in a second subsequent direction so as to align a second subsequent sub-image of the scene, displayed on the screen responsive to the second subsequent direction, with the second translated sub-image;
capturing the second subsequent sub-image; and
stitching the initial sub-image and the subsequent sub-image and the second subsequent sub-image together to form the panoramic image of the scene.

30. Apparatus for producing a panoramic image of a scene, comprising:
an image capture device which is pointed in an initial direction at the scene;
a screen which displays an initial sub-image responsive to the initial direction; and
a central processing unit (CPU) which is adapted to capture the initial sub-image of the scene, and to translate the initial sub-image a predetermined distance on the screen to form a translated sub-image,
wherein the image capture device is moved to point in a subsequent direction so as to align a subsequent sub-image of the scene, displayed on the screen responsive to the subsequent direction, with the translated sub-image, and wherein the CPU is adapted to capture the subsequent sub-image of the scene and to stitch the initial sub-image and the subsequent sub-image together to form the panoramic image of the scene.
